(19) United States
(12) Patent Application Publication
(10) Pub. No.: US 2011/0240402 A1
(43) Pub. Date: Oct. 6, 2011

(54) UNIT WITH A SOUND ISOLATION/VIBRATION ISOLATION STRUCTURE, ARRAY EMPLOYING THE SAME, AND METHOD FOR FABRICATING THE SAME

(75) Inventors: Jung-Tsung Chou, Taoyuan County (TW); Ting-Chu Lu, Taoyuan County (TW); Yu-Tsung Chiu, Taipei City (TW); Horng-Yuan Wen, Taoyuan County (TW); Hui-Lung Kuo, Taipei City (TW); Ping-Chen Chen, Taipei City (TW); Yi-Chun Liu, Taoyuan County (TW); Wen-Liang Liu, Hsinchu City (TW); Sheng-Wen Lin, Taipei County (TW)

(73) Assignee: INDUSTRIAL TECHNOLOGY RESEARCH INSTITUTE, Hsinchu (TW)

(21) Appl. No.: 12/860,795

(22) Filed: Aug. 20, 2010

(30) Foreign Application Priority Data
Mar. 31, 2010 (TW) TW99109809

(51) Int. Cl. F16F 15/00; B23P 19/04

(52) U.S. Cl. 181/207; 29/428

(57) ABSTRACT

The disclosure provides a unit with a sound isolation/vibration isolation structure, an array employing the same, and a method for fabricating the same. The unit with a sound isolation/vibration isolation structure includes: a hollow frame surrounding an inside space; a film disposed within the inside space, vertically contacting an inside wall of the hollow frame; and a body mass disposed on a top surface of the film. Particularly, the horizontal area of the inside space is larger than the area of the top surface of the film.

### CROSS REFERENCE TO RELATED APPLICATIONS

This application is based upon and claims the benefit of priority from the prior Taiwan Patent Application No. 099109809, filed on Mar. 31, 2010, the entire contents of which are incorporated herein by reference.

### TECHNICAL BACKGROUND

1. Technical Field

The present disclosure relates to a unit with a sound isolation/vibration isolation structure, and in particular relates to a unit with a sound isolation/vibration isolation structure classified as a negative mass system.

2. Description of the Related Art

Structures with energy dissipation means have been widely utilized for sound isolation/vibration isolation. In a conventional sound isolation/vibration isolation technique, energy dissipation is achieved through the deformation of a damping material.

Conventional damping devices (see, for example U.S. Pat. No. 6,012,543, U.S. Pat. No. 6,082,489, U.S. Pat. No. 5,854,453, and U.S. Pat. No. 5,543,198), achieving desired energy dissipation through the deformation of a damping material or the compression of air, have several inherent disadvantages. For example, the energy cannot be reused, the frequency cannot be adjusted, the damping device is opaque and an essential buffer space is desired.

Therefore, a damping device with a novel sound isolation/vibration isolation structure for solving the aforementioned problems of the conventional damping device is called for.

### TECHNICAL SUMMARY

Accordingly, the disclosure provides a unit with a sound isolation/vibration isolation structure blocking the transmission of a soundwave or a stress wave in a designed frequency range. Further, the material, mass, and Young's modulus of the components of the unit can be optimally adjusted or selected to correspond with a designed frequency range.

In an embodiment of the disclosure, the unit with a sound isolation/vibration isolation structure comprises a hollow frame with an inside space, a film disposed within the inside space, vertically contacting an inside wall of the hollow frame, and a first body mass disposed on a top surface of the film, wherein, the horizontal area of the inside space is larger than the area of the top surface of the film.

Further, in another embodiment of the disclosure, an array having a plurality of units is provided. The array comprises at least one carrier substrate, and a plurality of the aforementioned units with a sound isolation/vibration isolation structure embedded and passed through the at least one carrier substrate, wherein the hollow frames of any two adjacent units with a sound isolation/vibration isolation structure are separated by a specific distance.

Moreover, in yet another embodiment of the disclosure, a method for fabricating a unit with a sound isolation/vibration isolation structure is provided. The method comprises the following steps: providing a hollow frame with an inside space; disposing a film within the inside space, wherein the film vertically contacts the inside wall of the hollow frame; and disposing a first body mass on the top surface of the film, wherein the horizontal area of the inside space is larger than that of the area of the top surface of the film.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a schematic diagram of a unit with a sound isolation/vibration isolation structure according to an embodiment of the disclosure.

FIG. 2 is a top view of the unit with a sound isolation/vibration isolation structure as shown in FIG. 1.

FIG. 3 is a cross section along line 3-3′ of the unit with a sound isolation/vibration isolation structure as shown in FIG. 1.

FIGS. 4-6 are top views of units with a sound isolation/vibration isolation structure according to some embodiments of the disclosure.

FIGS. 7 and 8 are cross sections of units with a sound isolation/vibration isolation structure according to some embodiments of the disclosure.

FIGS. 9a and 9b are cross-sections showing a method of fabricating a unit with a sound isolation/vibration isolation structure by an imprinting process.

FIGS. 10 and 11 are schematic diagrams of an array employing the units with a sound isolation/vibration isolation structure according to some embodiments of the disclosure.

FIG. 12 is a graph plotting the measurement results of the unit with a sound isolation/vibration isolation structure of Example 1.

FIG. 13 is a graph plotting the measurement results of the stacked units with a sound isolation/vibration isolation structure of Example 2.

### DESCRIPTION OF THE DISCLOSURE EXEMPLARY EMBODIMENTS

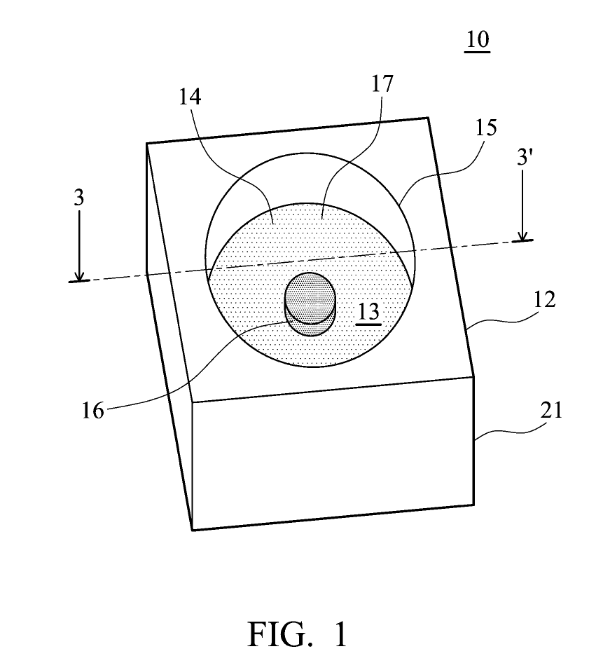

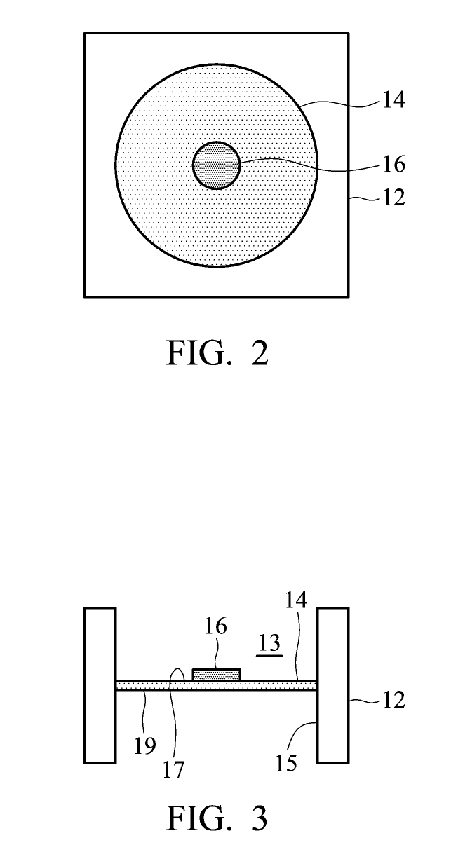

According to an embodiment of the disclosure, a unit with a sound isolation/vibration isolation structure 10, as shown in FIG. 1, includes a hollow frame 12, wherein the hollow frame 12 has an inside space 13. A film 14 is disposed within the inside space 13, wherein the film 14, vertically contacts the inside wall 15 of the hollow frame 12. A first body mass 16 (such as high mass or high density material) is disposed on a top surface 17 of the film 14. The inside space has a horizontal cross-section, wherein the horizontal cross-section has a shape selected from a group of shapes consisting of a circle, and a polygon. The hollow frame 12 has a contour 21 selected from a group of shapes consisting of a circle, and a polygon. The hollow frame 12 is connected with the first body mass 16 via the film 14 (as shown in FIG. 2, a schematic top view of FIG. 1). The unit with a sound isolation/vibration isolation structure 10 functions as a vertical spring, and the first body mass 16 disposed on the film 14 moves upward and downward along an axis perpendicular to the film (as shown in FIG. 3, a cross-section of FIG. 1 along line 3-3′).

The material of the hollow frame 12, the film 14, and the first body mass 16 are not limited and can be polymer, metal, organic compound, or inorganic compound. In an embodiment of the disclosure, suitable material of the film 14 can have a Young's modulus between 0.1 Mpa and 100 Gpa, and the thickness of the film 14 is between 10 nm and 10 mm.

A key feature of the disclosure is that the unit 10 can block the transmission of a soundwave or a stress wave in a designed frequency range through the selection of the mass of the hollow frame 12 and the first body mass 16, and the adjustment of the Young's modulus and the geometrical shape (or dimension) of the film 14.

The unit with a sound isolation/vibration isolation structure 10 of the disclosure can block a soundwave or stress wave with a frequency range between ω₀ and ω₀′, wherein ω₀ and ω₀′ are determined by the mass of the hollow frame M, the mass of the first body mass m, and the equivalent elastic coefficient k of the film in a direction perpendicular to the film (determined by the geometrical shape and the Young's modulus of the film), as described by the following equations:

ω₀=\sqrt{k/m}; and

ω₀′=ω₀\sqrt{M+m/M}

When the frequency range of the unit is between ω₀ and ω₀′, the unit with a sound isolation/vibration isolation structure can be regarded as a negative mass system.

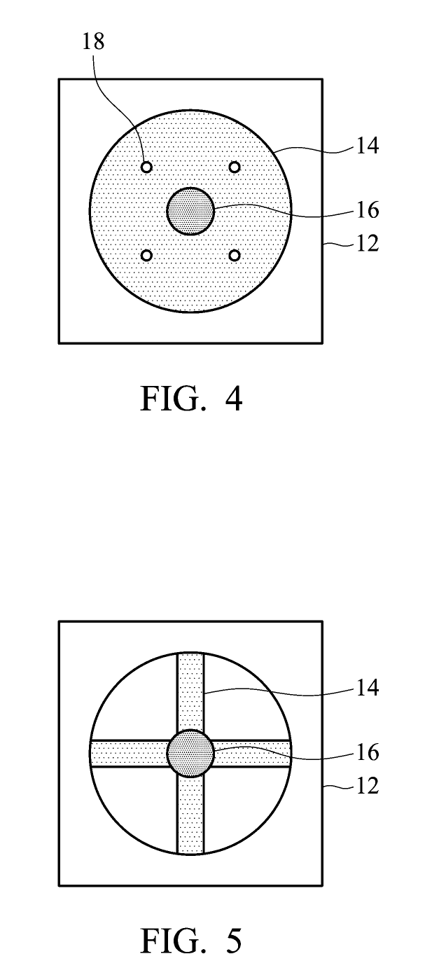

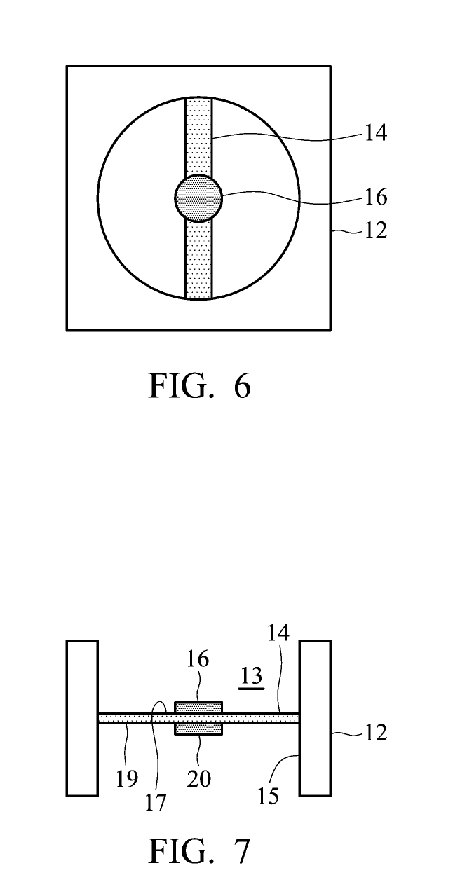

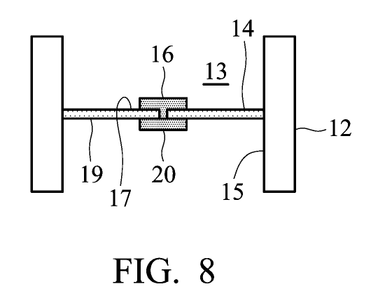

According to an embodiment of the disclosure, the mass of the hollow frame is between 0.1 mg and 1000 kg, the mass of the first body mass is between 0.1 mg to 1000 kg, and the equivalent elastic coefficient k of the film in a direction perpendicular to the film is between 0.01 (N/mm) and 1000 (N/mm). Further, the frequency of the unit with a sound isolation/vibration isolation structure can be between 0.1 Hz and 100 kHz. It should be noted, that in order to adjust the blocking frequency of a soundwave or a stress wave, the film 14 of the disclosure can have at least one hollow region 18 so that the cross-sectional area A1 of the inside space 13 is larger than the area A2 of the top surface of the film 14, as shown in FIG. 4. Namely, the area A2 of the top surface of the film 14 is set equal to the cross-sectional area A1 of the inside space 13 minus the area of the hollow region 18. Therefore, the equivalent elastic coefficient k of the film in a direction perpendicular to the film can be adjusted by modifying the geometric shape of the film. In theory, the equivalent elastic coefficient k of the film in a direction perpendicular to the film is varied in direct proportion to the ratio A2/A1. In some embodiments of the disclosure, the film can be bar-shaped, cross-shaped, or sheet-shaped, as shown in FIGS. 5 and 6. On other hand, the shape of the hollow region can be selected from a group of shapes consisting of a circle, a polygon, a sector, and an irregular shape. In another embodiment of the disclosure, as shown in FIG. 7, the unit with a sound isolation/vibration isolation structure 10 can further include a second body mass 20 disposed on a bottom surface 19 of the film 14. Further, the first body mass 16 can pass through the film 14 and directly contact to the second body mass 20, as shown in FIG. 8.

According to an embodiment of the disclosure, the method for fabricating a unit with a sound isolation/vibration isolation structure can include the following steps. First, a hollow frame is provided, wherein the hollow frame has an inside space. Next, a film is disposed within the inside space, wherein the film vertically contacts to an inside wall of the hollow frame. Finally, a first body mass is disposed on a top surface of the film. It should be noted that, when the area A1 of the inside space is larger than the area of the top surface of the film A2 (resulting in a lower equivalent elastic coefficient k of the film), the unit with a sound isolation/vibration isolation structure is apt to be used for blocking the transmission of a soundwave or a stress wave with a lower frequency.

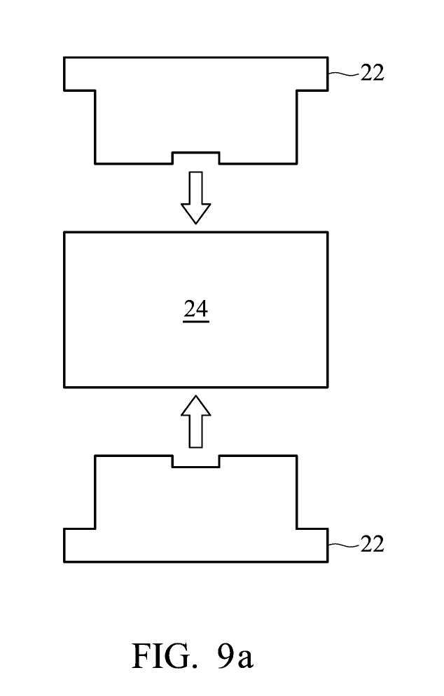

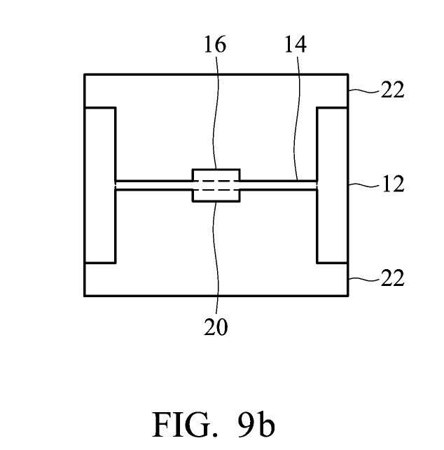

In an embodiment of the disclosure, the first body mass, the film, and the hollow frame can be formed by a roll-to-roll process, photolithography, electroforming, computer numerical control (CNC) machining, or laser machining process. Further, in an embodiment of the disclosure, the first body mass, the film, and the hollow frame can be simultaneously formed by using single process. For example, as shown in FIGS. 9a and 9b, a material 24 can be subjected to an imprinting process via a mold 22, fabricating a unit with a sound isolation/vibration isolation structure 10. Further, the first body mass can be also formed on the film by an ink-jet printing, dispensing, electroplating, electroforming, or self-assembly process. The method for fabricating a unit with a sound isolation/vibration isolation structure can further include disposing a second body mass on a bottom surface of the film, wherein the first body mass can pass through the film and directly contact the second body mass.

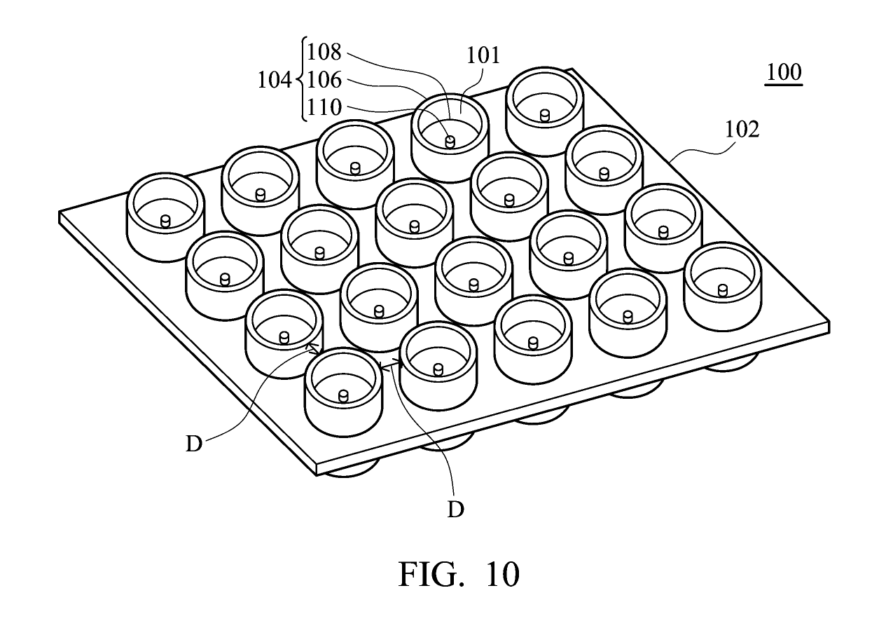

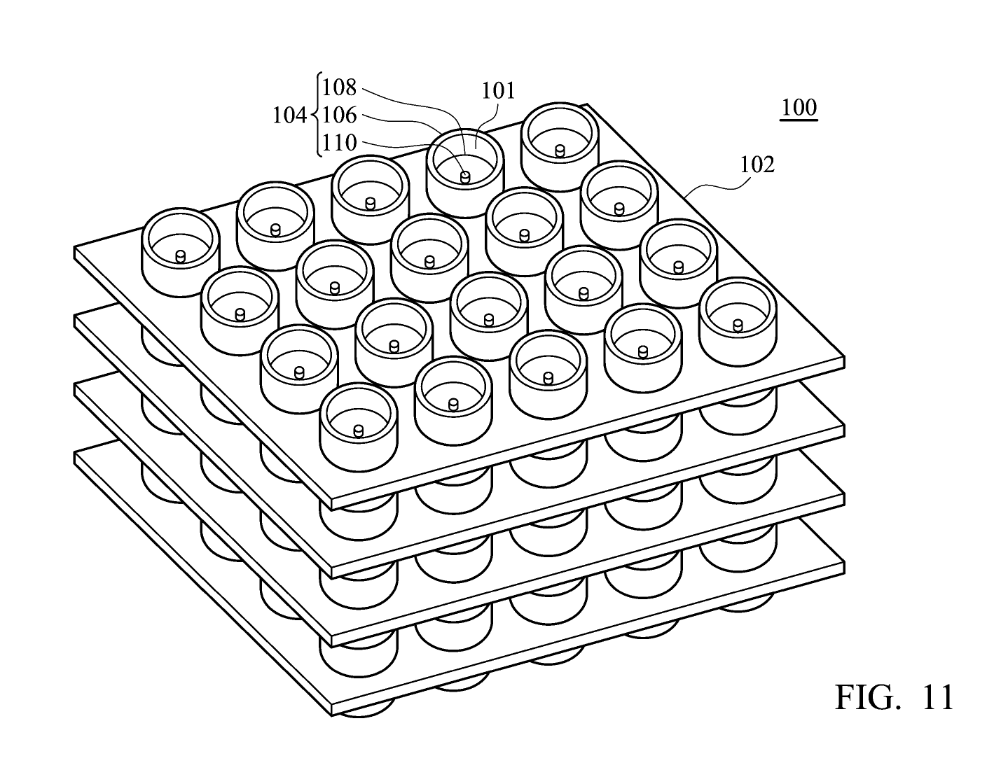

In some embodiments of the disclosure, an array 100 is provided, as shown in FIG. 10. The array can include at least one carrier substrate 102; and a plurality of units 104 with a sound isolation/vibration isolation structure embedded and passed through the at least one carrier substrate 102. Each unit 104 with the sound isolation/vibration isolation structure can include a hollow frame 106 with an inside space 101, a film 108 disposed within the inside space 101, vertically contacting an inside wall of the hollow frame, and a first body mass 110 disposed on a top surface of the film 108. It should be noted, in the array 100, the hollow frames 106 of any two adjacent units 104 with sound isolation/vibration isolation structures are separated by a specific distance D, and the unit number in the array can be adjusted by modifying the specific distance D. Due to the specific distance D, the adjacent units 104 do not interfere with each other by the frames thereof. The specific distance can be between 100 nm and 100 cm. The units with sound isolation/vibration isolation structures can be orderly or randomly arranged in the at least one carrier substrate. Further, the array can have a mono-layered structure or a multi-layered structure (equal to or more than two carrier substrates stacked with each other), as shown in FIG. 11.

The following examples are intended to illustrate the disclosure more fully without limiting their scope, since numerous modifications and variations will be apparent to those skilled in the art.

### Example 1

First, several acrylic hollow tubes were provided to serve as the hollow frame, wherein each tube had a thickness of 2 mm, a length of 2.5 cm, a diameter of 5 cm, and a weight of 10.5 g, several plastic films were provided, wherein each film had a thickness of 80 μm and an equivalent elastic coefficient (k) of 50.6 kg/m and several copper blocks were provided to serve as the body mass, wherein each copper block had a weight of 3.7 g. Next, the acrylic hollow tube, the film, and the copper block were then assembled to form a unit with a sound isolation/vibration isolation structure, wherein the unit with a sound isolation/vibration isolation structure had a local resonance frequency of less than 100 Hz.

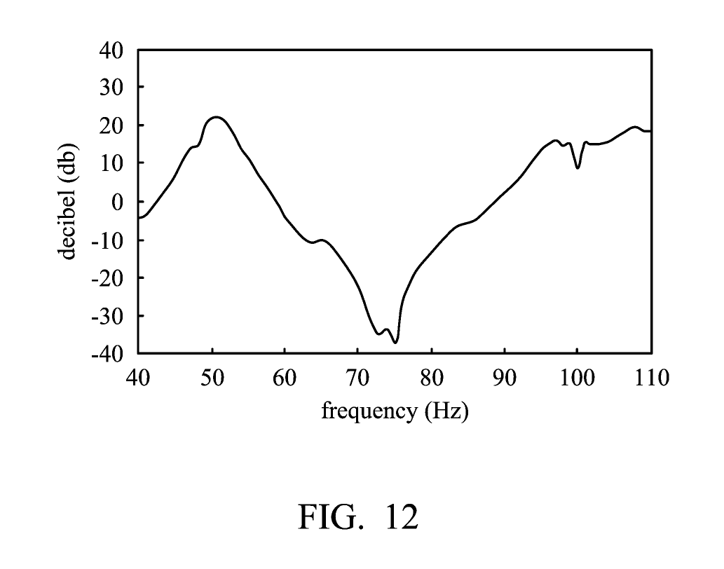

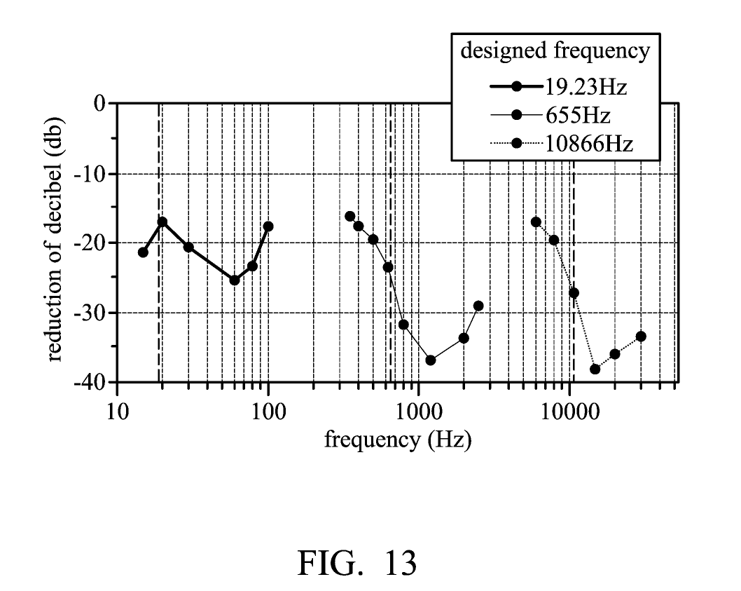

Next, a vibration with a low frequency was provided to the unit by a piezoelectric device, and the response amplitude of the unit was measured by an optical fiber interferometer in a sweep mode. During measurement of the response amplitude, the exciting frequency was gradually increased, and the input amplitude and the response amplitude were simultaneously measured. After normalization, the decibel level results, were as shown in FIG. 12.

When the vibration frequency was greater than 59 Hz, the energy underwent negative mass effect; thereby generating a standing wave (the standing wave is of the opposite phase from the frame), and decaying the response amplitude. As shown in FIG. 12, the unit had a frequency bandwidth (negative decibel values) of 30 Hz (between 59 Hz and 88 Hz), and the maximum decibel level reduction was 40 decibels.

### Example 2

In order to determine the blocking function of the unit with a sound isolation/vibration isolation structure, the model of the unit was constructed using the finite element software ANSYS. The unit included a PET (Poly(ethylene terephthalate)) circular frame (having a Young's modulus of 3 Gpa), and a PET film disposed within the inside space of the frame. A body mass with high density (such as copper with a density of 8.92 g/cm3) was disposed on the center of the film. Further, when stacking the units with a sound isolation/vibration isolation structure, a PDMS (poly-dimethylsiloxane, having a Young's modulus of 800 kPa) layer (serving as an intermediate layer) was used to separate two adjacent circular frames. The PDMS layer was at least 1000 times softer than the PET film. The intermediate layer prevented transmission of a stress wave via the frame.

The dimensions of each components of the unit with a sound isolation/vibration isolation structure were varied according to a desired frequency. Herein, the units with a sound isolation/vibration isolation structure were designed in connection with the blocking frequencies of 19.23 Hz, 655 Hz, and 10866 Hz respectively. The dimensions of each component of the three units are listed in Table 1.

TABLE 1

| Unit No. | 1 | | 2 | | 3 | |
|---|---|---|---|---|---|---|
| frequency | 10866 | Hz | 655 | Hz | 19.23 | Hz |
| Frame | 1.6 | mm × | 25 | mm × | 450 | mm × |
| dimension | 1.6 | mm × | 25 | mm × | 450 | mm × |
| | 0.96 | mm | 15 | mm | 270 | mm |
| | (thickness) | | (thickness) | | (thickness) | |
| Film | 1.44 | mm | 22.5 | mm | 405 | mm |
| diameter | | | | | | |
| Film | 20 | um | 300 | um | 3.5 | mm |
| thickness | | | | | | |
| Body mass | 1.12 | mm | 17.5 | mm | 315 | mm |
| diameter | | | | | | |
| Body mass | 0.64 | mm | 15 | mm | 180 | mm |
| thickness | | | | | | |

Next, five identical units were stacked together for a system of units, and a stress wave was input into the first unit of the system. The measurement results of the systems constituted respectively by the three types shown in Table 1 are shown in Table 13 and summarized below:

The unit with a sound isolation/vibration isolation structure No. 1 (with a designed frequency of 6 kHz˜30 kHz): had a maximum decibel level reduction of 37 decibels at 15000 Hz.

The unit with a sound isolation/vibration isolation structure No. 2 (with a designed frequency of 350 Hz˜2500 Hz): had a maximum decibel level reduction of 36 decibels at 1250 Hz.

The unit with a sound isolation/vibration isolation structure No. 3 (with a designed frequency of 15 Hz˜100 Hz): had a maximum decibel level reduction of 25 decibels at 60 Hz.

Accordingly, the disclosure provides a unit with a sound isolation/vibration isolation structure classified as a negative mass system. Further, the material, mass, and Young's modulus of the components (such as hollow frame, film, and body mass) of the unit can be optimally adjusted or selected to block a stress wave (or soundwave) with a specific frequency. Further, components (such as hollow frame, film, and body mass) of the unit with a sound isolation/vibration isolation can be integrally formed by a single process (such as a imprinting process).

In the unit with a sound isolation/vibration isolation structure and the array employing the same, since the body mass is disposed on the center of the film and can move upward and downward along an axis perpendicular to the film, the unit can function as a vertical spring. Therefore, the unit with a sound isolation/vibration isolation structure and the array employing the same can block the transmission of a soundwave or a stress wave in a designed frequency (or limit a soundwave or a stress wave transmitting in a fixed orientation). Further, the unit with a sound isolation/vibration isolation structure of the disclosure can be advantageously combined with a piezoelectric material adopted in a film to convert kinetic energy into an electrical current; thereby achieving efficient energy recovery. Moreover, in order to highlight the advantages of the unit with a sound isolation/vibration isolation structure of the disclosure, a comparison is made between the conventional damping system and the unit of the disclosure (a negative mass system), as shown in Table 2.

TABLE 2

| | mechanism | energy recovery | frequency | thickness | reliability |
|---|---|---|---|---|---|
| Damping | energy | unrecoverable | unselectable | thicker | unrecoverable |
| system | dissipation | (converting to thermal | | | damages may be |
| | | energy or permanent | | | occurred in a |
| | | deformation) | | | damping system |
| Negative | energy | recoverable (converting | selectable | thinner | recoverable structure |
| mass system | blocking | to kinetic energy) | | | (in an elastic limit) |

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A unit with a sound isolation/vibration isolation structure, comprising:
a hollow frame with an inside space;
a film disposed within the inside space, vertically contacting an inside wall of the hollow frame; and
a first body mass disposed on a top surface of the film.

2. The unit with a sound isolation/vibration isolation structure as claimed in claim 1, wherein the thickness of the film is between 10 nm and 10 mm.

3. The unit with a sound isolation/vibration isolation structure as claimed in claim 1, wherein the Young's modulus of the film is between 0.1 Mpa and 100 Gpa.

4. The unit with a sound isolation/vibration isolation structure as claimed in claim 1, wherein the film is bar-shaped, cross-shaped, or sheet-shaped.

5. The unit with a sound isolation/vibration isolation structure as claimed in claim 1, wherein the film has at least one hollow region.

6. The unit with a sound isolation/vibration isolation structure as claimed in claim 5, wherein the hollow region has shapes selected from a group of shapes consisting of a circle, a polygon, a sector, and an irregular shape.

7. The unit with a sound isolation/vibration isolation structure as claimed in claim 1, wherein the inside space has a horizontal cross-section having a shape selected from a group of shapes consisting of a circle, a polygon, a sector, and an irregular shape.

8. The unit with a sound isolation/vibration isolation structure as claimed in claim 1, wherein the hollow frame has an outer contour selected from a group of shapes consisting of a circle, and a polygon.

9. The unit with a sound isolation/vibration isolation structure as claimed in claim 1, wherein the mass of the hollow frame is between 0.1 mg and 1000 kg.

10. The unit with a sound isolation/vibration isolation structure as claimed in claim 1, wherein the mass of the first body mass is between 0.1 mg to 1000 kg.

11. The unit with a sound isolation/vibration isolation structure as claimed in claim 1, wherein the equivalent elastic coefficient of the film in a vertical direction is between 0.01 (N/mm) and 1000 (N/mm).

12. The unit with a sound isolation/vibration isolation structure as claimed in claim 1, wherein the blocking frequency of the unit with a sound isolation/vibration isolation structure is between 0.1 Hz and 100 kHz.

13. The unit with a sound isolation/vibration isolation structure as claimed in claim 1, further comprising:
a second body mass disposed on a bottom surface of the film.

14. The unit with a sound isolation/vibration isolation structure as claimed in claim 13, wherein the first body mass passes through the film and directly contacts the second body mass.

15. The unit with a sound isolation/vibration isolation structure as claimed in claim 1, wherein the first body mass is integrally formed with the film and the hollow frame.

16. An array, comprising:
a carrier substrate; and
a plurality of units with sound isolation/vibration isolation structures embedded and passed through the carrier substrate, wherein each unit with a sound isolation/vibration isolation structure comprises:
a hollow frame with an inside space;
a film disposed within the inside space, vertically contacting an inside wall of the hollow frame; and
a first body mass disposed on a top surface of the film,
wherein the hollow frames of any two adjacent units with a sound isolation/vibration isolation structure are separated by a specific distance.

17. The array in claim 16, wherein the specific distance is between 100 nm and 100 cm.

18. The array in claim 16, wherein the plurality of units with sound isolation/vibration isolation structures are orderly or randomly arranged in the carrier substrate.

19. The array in claim 16, wherein the array has a mono-layered structure or a multi-layered structure.

20. A method for fabricating a unit with a sound isolation/vibration isolation structure, comprising:
providing a hollow frame with an inside space;
disposing a film within the inside space, wherein the film vertically contacts the inside wall of the hollow frame; and
disposing a first body mass on the top surface of the film,
wherein the horizontal area of the inside space is larger than that of the area of the top surface of the film.

21. The method as claimed in claim 20, wherein the first body mass, the film, and the hollow frame are simultaneously formed by using a single process.

22. The method as claimed in claim 20, wherein the first body mass, the film, and the hollow frame are formed by a roll-to-roll process, photolithography, electroforming, computer numerical control (CNC) machining, or laser machining process.

23. The method as claimed in claim 20, wherein the first body mass, the film, and the hollow frame are formed by an imprinting process.

24. The method as claimed in claim 20, wherein the first body mass is formed by an ink-jet printing, dispensing, electroplating, electroforming, or self-assembly process.

25. The method as claimed in claim 20, further comprising:
a second body mass disposed on a bottom surface of the film.

26. The method as claimed in claim 20, wherein the first body mass passes through the film and directly contacts the second body mass.

27. The unit with a sound isolation/vibration isolation structure as claimed in claim 1, wherein the horizontal area of the inside space is larger than the area of the top surface of the film.
